(19) United States
(12) Patent Application Publication
(10) Pub. No.: US 2016/0216792 A1
(43) Pub. Date: Jul. 28, 2016

(54) HEAD MOUNTED DISPLAY, AND CONTROL METHOD AND CONTROL PROGRAM FOR HEAD MOUNTED DISPLAY

(71) Applicant: SEIKO EPSON CORPORATION, Tokyo (JP)

(72) Inventors: Tomohiro OGAWA, Shiojiri-shi (JP); Susumu INOUE, Matsumoto-shi (JP); Takeshi KIMOTO, Shiojiri-shi (JP); Toru MATSUI, Azumino-shi (JP)

(73) Assignee: SEIKO EPSON CORPORATION, Tokyo (JP)

(21) Appl. No.: 15/000,548

(22) Filed: Jan. 19, 2016

(30) Foreign Application Priority Data
Jan. 26, 2015 (JP) 2015-012140
Feb. 10, 2015 (JP) 2015-023895

(51) Int. Cl. G06F 3/041; G06T 3/40; G02B 27/01; G06F 3/01

(52) U.S. Cl. CPC G06F 3/041; G06F 3/011; G06T 3/40; G02B 27/0172; G02B 27/0179; G02B 2027/0147

(57) ABSTRACT

A head mounted display includes a display unit that displays an image, a touch sensor provided along at least a part of a periphery of the display unit, and a control unit that changes the image in response to an operation detected by the touch sensor.

### BACKGROUND

1. Technical Field

The present invention relates to a head mounted display, and a control method and a control program for a head mounted display.

2. Related Art

In related art, spectacle-shaped head mounted displays (so-called smart glasses) have been known (for example, Patent Document 1 (JP-A-2014-174790)).

Operation methods for the smart glasses include a method of operating a touch pad separate from the smart glasses, and a method of making a gesture such as tapping fingers together with touch sensors attached to the finger tips as disclosed in Patent Document 1. However, in the operation methods of related art, there has been a problem that an intuitive operation is harder.

### SUMMARY

An advantage of some aspects of the invention is to provide an easy-to-operate head mounted display. Another advantage of some aspects of the invention is to provide a head mounted display that can easily start calibration for augmented reality function.

A head mounted display according to an aspect of the invention includes a display unit that displays an image, a touch sensor provided along at least a part of a periphery of the display unit, and a control unit that changes the image in response to an operation detected by the touch sensor. In the head mounted display, the user brings an object of a finger or the like into contact with the touch sensor provided along the periphery of the display unit, and thereby, the image displayed on the display unit may be changed. The display unit and a part to be operated are closer than those of a configuration in related art and the user may recognize the motion of the own finger or the like with respect to the part to be operated while visually recognizing the display unit, and thereby, the display may be operated more easily compared to the configuration in related art. Further, for example, compared to a configuration of inputting a command by a gesture of a finger or the like in the air (acquiring command details by analyzing an image formed by capturing the gesture), the configuration may perform an operation on a substantive object and may be easily operated by the user because of stability.

The display unit is formed to be located in front of the eye of the user when the user wears the head mounted display on the head, and displays the image. When the head mounted display has a spectacle shape, the display unit is a part corresponding to the lenses of the spectacles. Two of the display units may be provided for both eyes, or one display unit may be provided for one eye. According to an embodiment, the display unit has a form of a thin plate (may be curved), and the periphery of the display unit is e.g. a part formed by surfaces that define the thickness of the thin-plate part. The touch sensor is provided along at least a part of the periphery of the display unit, and this includes both the case where the touch sensor is provided directly on the display unit and the case where the touch sensor is provided on a support of a frame supporting the edge of the display unit or the like. In either case, the touch sensor is provided to extend in the peripheral direction of the display unit. Further, it is only necessary that the touch sensor may detect at least the contact position of the object in the peripheral direction of the display unit.

The control unit changes the image displayed on the display unit in response to the detection of the operation of the user by the touch sensor, and this includes an embodiment of changing the entire screen displayed on the display unit and an embodiment of changing part of the display elements within the screen. As the operations by the user on the touch sensor, in addition to rotation, pinch-in, pinch-out, and slide, which will be described later, various known operations may be assumed as the operations on the touch sensor and the touch panel including single-tap, double-tap, and hold-down.

In the head mounted display, the control unit may change the image in response to the operation by which two touch positions move in different directions from each other along the periphery. The user brings objects of fingers or the like into contact in two locations along the periphery of the display unit and moves (slides) the objects of fingers or the like so that touch positions may move in directions different from each other while keeping the contact, and thereby, may change the image displayed on the display unit. The user may command change modes of the image to the head mounted display by the touch position and the movement direction of the touch position.

In the head mounted display, the touch sensor may include a first touch sensor and a second touch sensor having a positional relationship sandwiching the display unit with the first touch sensor. In this case, the control unit may rotate the image in response to the operation represented by a movement of a first touch position in a first direction detected by the first touch sensor and a movement of a second touch position in a second direction opposite to the first direction detected by the second touch sensor.

The control unit is adapted to perform processing of rotating the image displayed on the display unit in response to the operation of moving (sliding) the first touch position and the second touch position in the directions different from each other, and thereby, an intuitive operation method for rotating the image may be provided to the user.

In the head mounted display, the control unit may reduce the image in response to the operation by which the two touch positions move closer to each other. Further, the control unit may enlarge the image in response to the operation by which the two touch positions move away from each other.

The operation of moving two objects closer to each other on the touch sensor provided along the periphery of the display unit (so-called pinch-in operation) and processing of reducing and displaying the image are associated, and thereby, an intuitive operation method may be provided to the user. Further, the operation of moving two objects away from each other on the touch sensor (so-called pinch-out operation) and processing of enlarging and displaying the image are associated, and thereby, an intuitive operation method may be provided to the user. Note that, not only the direct image enlargement and reduction, but also e.g. summarization of the displayed information may be performed in response to the pinch-in operation or detailing of the information may be performed in response to the pinch-out operation.

In the head mounted display, the control unit may move a display position of the image in response to the operation by which one touch position moves along the periphery. The user performs an operation of moving (sliding) the object in the peripheral direction on the touch sensor provided along the periphery of the display unit, and thereby, the display position of the image displayed on the display unit may be moved.

Note that, as described above, the technique of changing the image displayed on the display unit in response to the operation detected by the touch sensor provided along at least a part of the periphery of the display unit can be implemented as the invention directed to a control method and the invention directed to a control program for the head mounted display. Further, the above described functions of the respective units are implemented by a hardware source with a function specified by the configuration itself, a hardware source with a function specified by the program, or a combination of them. Furthermore, the functions of the respective units are not limited to those implemented by hardware sources physically independent of one another.

A head mounted display according to another aspect of the invention includes a sensor that detects a change in position with respect to a head of a user, and a control unit that executes predetermined processing when the change in position is detected.

The head mounted display includes the sensor that detects the change in position with respect to the head of the user, and thereby, the change of the position of the head mounted display with respect to the head by the user may be detected and the control unit may execute predetermined processing in response to the detection. Thus, the head mounted display by which the operation for executing the predetermined processing is easy may be provided. The predetermined processing here may include calibration for augmented reality function or transition of an image or screen with the calibration.

The control unit can change the processing details performed until then when detecting the change in position with respect to the head based on sensor output, and, as a result, change e.g. the image of the display unit. The image displayed on the display unit may be changed as a result of the change in processing details of various forms. For example, the image may be changed as a result of the suspend, stop, switch (activation of new processing after suspend or stop) of the processing itself executed by the control unit until the position change is detected or may be changed as a result of continuation of the processing executed until the position change is detected and switch of data to be processed. Further, the change form of the image displayed on the display unit includes various forms such as a form of changing the entire image displayed on the display unit and a form changing a part of the image.

Note that the sensor is relatively fixed to the head mounted display, and the detection of the change in position with respect to the head of the user by the sensor shows that the position of the head mounted display itself with respect to the head of the user is changed. Further, the control unit may determine presence or absence of the position change based on output of a single sensor or may determine presence or absence of the position change based on output of a plurality of kinds of sensors.

The head mounted display may have a spectacle shape, and, in this case, the sensor may include a touch sensor provided on a bridge. Note that the bridge is a part located between two lenses in the spectacles and corresponding to the part connecting the two lenses. When the head mounted display has the spectacle shape, the display unit may be provided in each corresponding part of the two lenses or provided only in the corresponding part of one lens. The part corresponding to the lens is a part corresponding to the part of the lens in the spectacles.

When the touch sensor is provided in the bridge, the head mounted display may detect the change of the position of the head mounted display with respect to the head by the user by pushing up the bridge with the finger or the like in contact with the touch sensor or otherwise, and the predetermined processing may be executed in response to the detection of the change in position.

When the head mounted display has the spectacle shape, the sensor may include a touch sensor provided on a temple. Note that the temple is a part connected to the lens part and corresponding to the part extended to hang on the ear in the spectacles, and also called “arm” or the like. The touch sensor may be provided on both temples or on only one temple. The spectacle-shaped head mounted display with the touch sensor on the temple may detect the change of the position of the head mounted display with respect to the head by touching of the temple, and the predetermined processing may be executed in response to the detection of the change in position.

In the head mounted display, the sensor may include a touch sensor and a motion sensor. Further, the control unit may execute the predetermined processing when the touch sensor detects contact and the motion sensor detects a motion. In the case of the configuration, the head mounted display may detect the motion of changing the position with respect to the head by the user in contact with the head mounted display using the motion sensor and the touch sensor provided in the contact part of the user. Further, the predetermined processing may be executed in response to the detection of the change in position. Note that, if the change in position is detected using only the motion sensor, for example, walking and the simple vertical motion of the head by the user and the intentional motion of adjusting the position of the head mounted display are harder to be distinguished. The touch sensor and the motion sensor are combined as in the configuration, and thereby, they may be easily distinguished and erroneous motion may be prevented.

Note that, in the case of the configuration, the touch sensor may be provided in any location of the head mounted display, for example, when the head mounted display has the spectacle shape, the touch sensor may be provided on the bridge or temple as described above. Obviously, the touch sensor may be provided in e.g. a part corresponding to the lens of the spectacles or the frame part (frame) supporting the part corresponding to the lens. Further, the motion sensor may be provided in any location of the head mounted display, for example, in a part in which displacement is larger by the motion of changing the position in the head mounted display. The motion sensor may be any sensor as long as it may detect the motion of the head mounted display. For example, an acceleration sensor, a gyro sensor, or the like may be assumed.

In the head mounted display, when detecting the change in position, the control unit may switch contents in reproduction. The contents in reproduction may be e.g. still images during slide show, music, or moving images. The control unit executes predetermined processing of continuing reproduction processing, but switching the contents (data to be reproduction-processed). The motion of changing the position of the head mounted display with respect to the head and the switching of the contents in reproduction are associated, and thereby, an intuitive command input method may be provided to the user.

Alternatively, when detecting the change in position, the control unit may start calibration processing of an augmented reality function. It is considered that, when the user desires to perform calibration for augmented reality function, the user adjusts the position of the head mounted display with respect to the head and starts calibration. The motion of position adjustment and the start of calibration processing are associated, and thereby, the head mounted display having the configuration may provide an intuitive and simple input method of a start command of calibration to the user.

Alternatively, in the case where a display unit that displays an image is further provided, when detecting the change in position, the control unit may allow the display unit to display an image representing a home screen. That is, in the case of the configuration, the user performs a simple motion of changing the position of the head mounted display with respect to the head, and thereby, may switch to the home screen in the display unit. Note that the home screen refers to a screen as a base of all operations. For example, a screen after the power of the head mounted display is turned on and the operating system is activated and before some processing is performed in response to a command of the user may be assumed.

Note that, as described above, the technique of executing predetermined processing when detecting the change of the head mounted display in position with respect to the head of the user can be implemented as the invention directed to a control method and the invention directed to a control program of the head mounted display. Further, the above described functions of the respective units are implemented by a hardware source with a function specified by the configuration itself, a hardware source with a function specified by the program, or a combination of them. Furthermore, the functions of the respective units are not limited to those implemented by hardware sources physically independent of one another.

### BRIEF DESCRIPTION OF THE DRAWINGS

The invention will be described with reference to the accompanying drawings, wherein like numbers reference like elements.

FIG. 1 is an appearance diagram showing smart glasses.

FIG. 2 is a block diagram showing the smart glasses.

FIGS. 3A, 3C, 3E show display examples, and FIGS. 3B and 3D show operation examples.

FIGS. 4A, 4C, 4E show display examples, and FIGS. 4B and 4D show operation examples.

FIGS. 5A, 5C, 5E show display examples, and FIGS. 5B and 5D show operation examples.

FIGS. 6A to 6E show flowcharts according to a first embodiment.

FIG. 7 is an appearance diagram showing smart glasses.

FIG. 8 is a block diagram showing the smart glasses.

FIG. 9 is a diagram for explanation of a motion of changing a position of an attachment body with respect to a head.

FIG. 10 is a diagram for explanation of a motion of changing the position of the attachment body with respect to the head.

FIGS. 11A and 11B show flowcharts according to a second embodiment.

### DESCRIPTION OF EXEMPLARY EMBODIMENTS

Hereinafter, embodiments of the invention will be explained in the following order with reference to the accompanying drawings. In the respective drawings, corresponding component elements have the same signs and their overlapping explanation will be omitted.

### 1. First Embodiment

### 1-1. Configuration

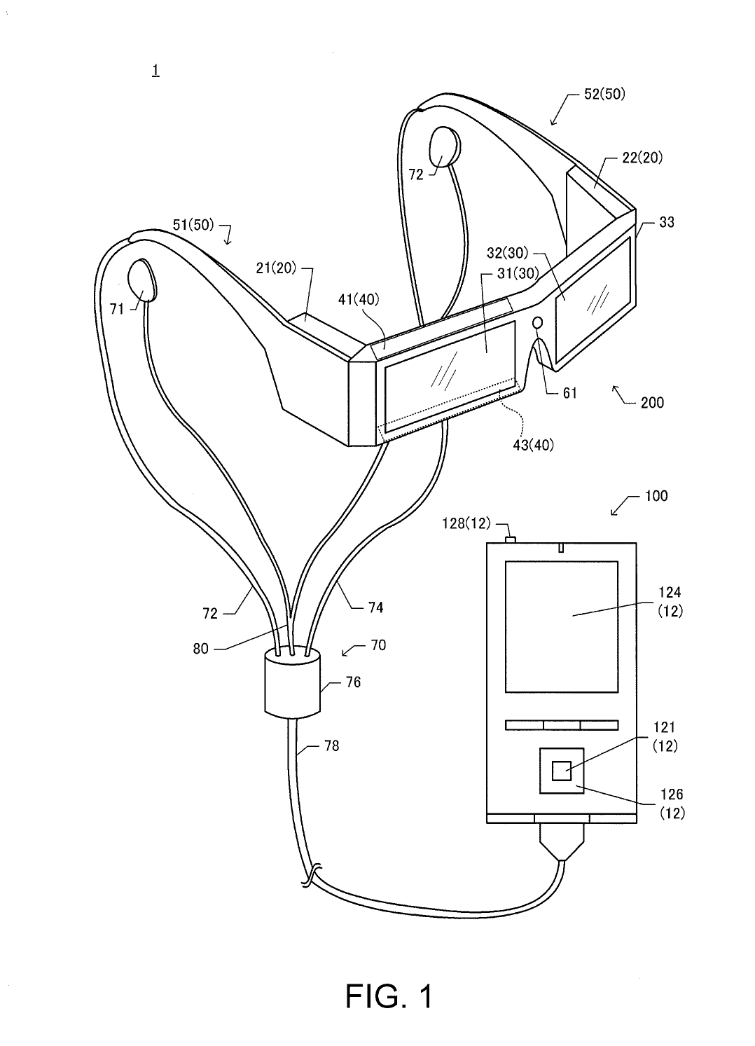

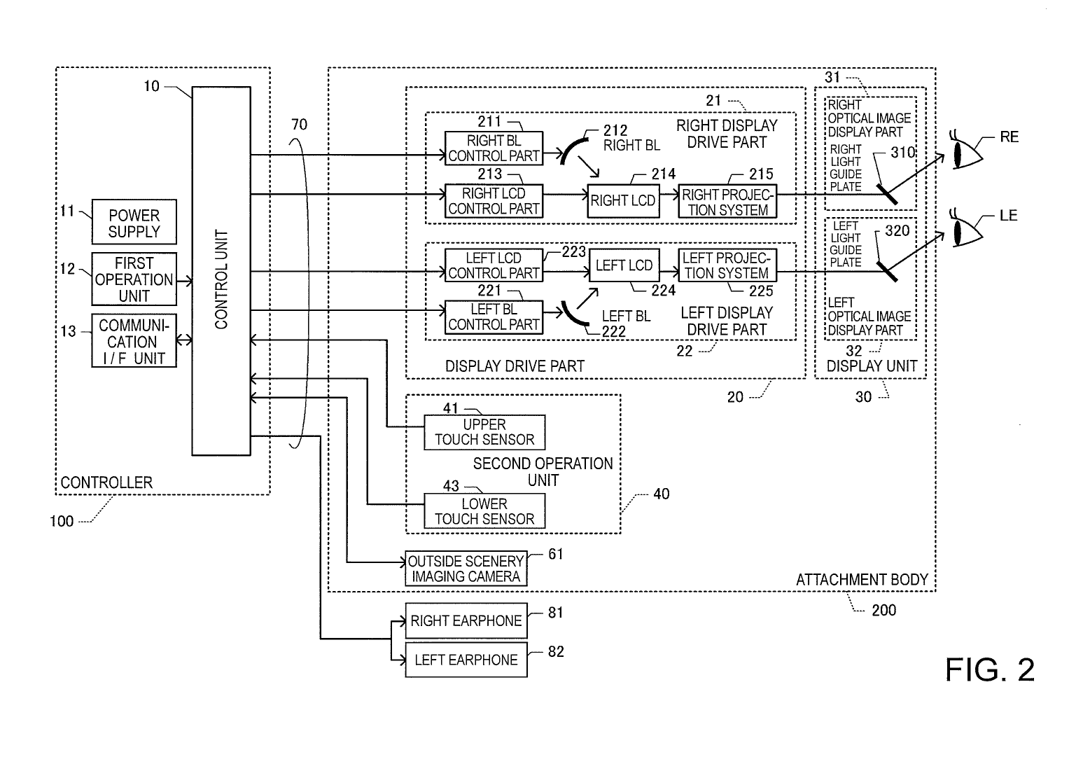

FIG. 1 is an explanatory diagram showing an appearance configuration of smart glasses 1 as a head mounted display (HMD). FIG. 2 is a block diagram functionally showing a configuration of the smart glasses 1. The smart glasses 1 of the embodiment is an optically transmissive HMD that enables a user to visually recognize an image (display image) displayed on a display unit and directly visually recognize an outside scenery.

The smart glasses 1 include an attachment body 200 that allows a user to visually recognize a display image when worn on the head of the user, and a controller 100 that controls the attachment body 200. The attachment body 200 has a spectacle shape in the embodiment. The attachment body 200 includes a display unit 30 as a part corresponding to lenses of the spectacles, a frame part 33 that supports the edges of the display unit 30, holding parts 50 connected to the frame part 33 and hanging on the ears of the user in wearing, a display drive unit 20, a second operation unit 40, and an outside scenery imaging camera 61. Note that, in the specification, “up”, “down, “left”, and “right” refer to “up”, “down, “left”, and “right” for a user when the attachment body 200 is attached to the head of the user.

The display unit 30 includes a right optical image display part 31 and a left optical image display part 32. The right optical image display part 31 and the left optical image display part 32 are placed to be located in front of right and left eyes of the user when the user wears the attachment body 200, respectively. The edges of the right optical image display part 31 and the left optical image display part 32 are fixed to the frame part 33. The holding parts 50 include a right holding part 51 and a left holding part 52. The right holding part 51 and the left holding part 52 hold the attachment body 200 on the head of the user like temples of the spectacles. The display drive unit 20 includes a right display drive part 21 and a left display drive part 22. The right display drive part 21 and the left display drive part 22 are placed inside of the holding parts 50, i.e., on the sides of the holding parts 50 opposed to the head of the user when the user wears the attachment body 200.

The right display drive part 21 includes a right backlight (BL) control part 211 and a right BL 212 that function as a light source, a right LCD control part 213 and a right LCD 214 that function as a display device, and a right projection system 215. The right projection system 215 includes a collimator lens that brings image light output from the right LCD 214 into parallelized luminous fluxes. The right optical image display part 31 includes a right light guide plate 310 and a dimmer plate (not shown). The right light guide plate 310 guides the image light output from the right projection system 215 to the right eye RE of the user while reflecting the light along a predetermined optical path.

The left display drive part 22 includes a left backlight (BL) control part 221 and a left BL 222 that function as a light source, a left LCD control part 223 and a left LCD 224 that function as a display device, and a left projection system 225. The left projection system 225 includes a collimator lens that brings image light output from the left LCD 224 into parallelized luminous fluxes. The left optical image display part 32 includes a left light guide plate 320 and a dimmer plate (not shown). The left light guide plate 320 guides the image light output from the left projection system 225 to the left eye LE of the user while reflecting the light along a predetermined optical path.

The right light guide plate 310 and the left light guide plate 320 are formed using a light-transmissive resin material or the like. The dimmer plates are optical elements having thin plate shapes, and provided to cover the front side of the attachment body 200 as the opposite side to the sides of the eyes of the user. The dimmer plates protect the light guide plates 310, 320 and suppress damage on the light guide plates 310, 320, adhesion of dirt, etc. Further, the light transmittance of the dimmer plates is adjusted, and thereby, the amount of outside light entering the eyes of the user may be adjusted and ease of visual recognition of the display image may be adjusted. Note that the dimmer plates may be omitted.

The second operation unit 40 includes an upper touch sensor 41 and a lower touch sensor 43. The upper touch sensor 41 is provided on the front surface of the frame part 33 along the upper part of the periphery of the right optical image display part 31 (the upper part when the periphery is divided to four of up, down, left, right, the upper part is on the top side of the head of the user when the attachment body 200 is attached). The lower touch sensor 43 is provided on the front surface of the frame part 33 along the lower part of the periphery of the right optical image display part 31 (the chin side of the user when the attachment body 200 is attached). Further, touch sensor I/F parts (not shown) respectively connected to the upper touch sensor 41 and the lower touch sensor 43 are provided inside of the frame part 33.

When a contact operation is performed on the upper touch sensor 41, the touch sensor I/F part of the upper touch sensor 41 outputs a signal representing the contact position to the control unit 10. Similarly, when a contact operation is performed on the lower touch sensor 43, the touch sensor I/F part of the lower touch sensor 43 outputs a signal representing the contact position to the control unit 10. In the embodiment, touch sensors that detect one-dimensional coordinates are used for the upper touch sensor 41 and the lower touch sensor 43 because it is only necessary that the sensors may detect the contact position in the peripheral direction of the right optical image display part 31.

The outside scenery imaging camera 61 is provided in a position corresponding to the glabella of the user when the user wears the attachment body 200. The outside scenery imaging camera 61 images an outside scenery as a scenery outside and acquires an outside scenery image. The outside scenery imaging camera 61 in the embodiment is a monocular camera, however, a stereo camera may be employed.

The attachment body 200 further has a connecting part 70 for connecting the attachment body 200 to the controller 100. The connecting part 70 includes a main body cord 78 connected to the controller 100, a right cord 72 and a left cord 74 bifurcated from the main body cord 78, and a coupling member 76. The right cord 72 is inserted into a casing of the right holding part 51 from an end of the right holding part 51 and connected to the right display drive part 21 and the touch sensor I/F part. The left cord 74 is inserted into a casing of the left holding part 52 from an end of the left holding part 52 and connected to the left display drive part 22. The coupling member 76 has a jack provided at the bifurcation point between the main body cord 78 and the right cord 72 and the left cord 74 for connection of an earphone plug 80. From the earphone plug 80, a right earphone 81 and a left earphone 82 extend. The attachment body 200 and the controller 100 transmit various signals via the connecting part 70. A connector is provided on the opposite end to the coupling member 76 in the main body cord 78 and can be attached to or detached from the controller 100.

The controller 100 is a device for controlling the smart glasses 1. The controller 100 includes the control unit 10, a power supply 11, a first operation unit 12, and a communication I/F unit 13. The control unit 10 includes a CPU, a RAM, a ROM, etc. and controls the smart glasses 1 by the CPU executing control programs recorded in the ROM and the RAM using the RAM etc. The control programs include an operating system, an operation receiving processing program, a display control program, an image processing program, a sound processing program, which will be described later, etc.

The first operation unit 12 includes an enter key 121, a track pad 124, an arrow key 126, a power switch 128, etc. The enter key 121 is a key, when a press operation is performed, for outputting a signal that determines an operation performed in the controller 100 and operation details performed in the second operation unit 40. The track pad 124 detects operations of fingers of the user etc. on the operation surface of the track pad 124, and outputs signals in response to the detected contents. The arrow key 126 is a key, when a press operation is performed on the key corresponding to the up, down, left, and right directions, for outputting a signal in response to the detected content. The power switch 128 is a switch, when a slide operation of the switch is performed, switches the power status of the smart glasses 1.

The communication I/F unit 13 includes an interface circuit for wired communication (e.g. USB or the like) or wireless communication (e.g. Wi-Fi (registered trademark), Bluetooth (registered trademark), or the like) between an external apparatus such as a contents server, a television, or a personal computer and itself.

The display control program allows the control unit 10 to realize a function of controlling generation and output of image lights by the respective left and right display drive parts 21, 22. Specifically, the function of individually controlling drive ON/OFF of the right LCD 214 by the right LCD control part 213, drive ON/OFF of the right BL 212 by the right BL control part 211, drive ON/OFF of the left LCD 224 by the left LCD control part 223, drive ON/OFF of the left BL 222 by the left BL control part 221, etc. is realized.

The image processing program allows the control unit 10 to realize a function of generating right-eye image data and left-eye image data based on image signals contained in data to be displayed and transmitting the data to the right display drive part 21 and the left display drive part 22, respectively. The sound processing program allows the control unit 10 to realize a function of acquiring sound signals contained in data to be reproduced, amplifying the acquired sound signals using amplifiers (not shown), and supplying the signals to speakers (not shown) within the left and right earphones 71, 72. The operation receiving program allows the control unit 10 to realize a function, when information representing that an operation for the first operation unit 12 and an operation for the second operation unit 40 are performed, of executing processing in response to the operations.

The control unit 10 executes the operating system, the display control program, the image processing program, and the operation receiving program, and thereby, the smart glasses 1 may execute processing in response to the operations of the user and give guidance to the user by changing information displayed on the display unit 30.

### 1-2: Operation Details and Changes of Display Images

As described above, the smart glasses 1 further include the second operation unit 40 in addition to the first operation unit 12 of the controller 100, and the user may perform the following operations using the second operation unit 40.

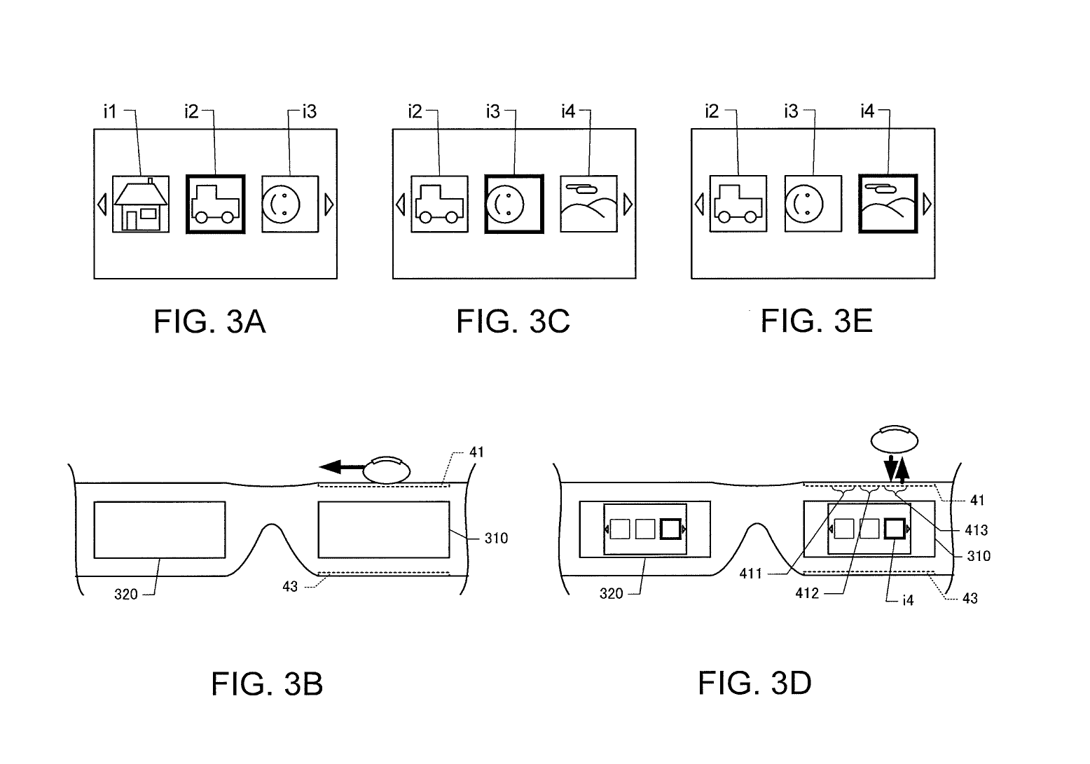

FIGS. 3A, 3C, 3E show screens displayed on the display unit 30 (the left and right light guide plates 310, 320) and visually recognized by the user. In the smart glasses 1, images may be captured by the outside scenery imaging camera 61. For example, FIGS. 3A, 3C, 3E show list display screens of images captured using the outside scenery imaging camera 61 in which three images of a plurality of images are displayed on the screens. Further, the image with the highlighted frame shows the selected image. The plurality of pieces of image data are managed in an interactive linked-list format by the control unit 10. That is, the pieces of image data are managed so that the image data to be displayed may be switched according to the ascending or descending order.

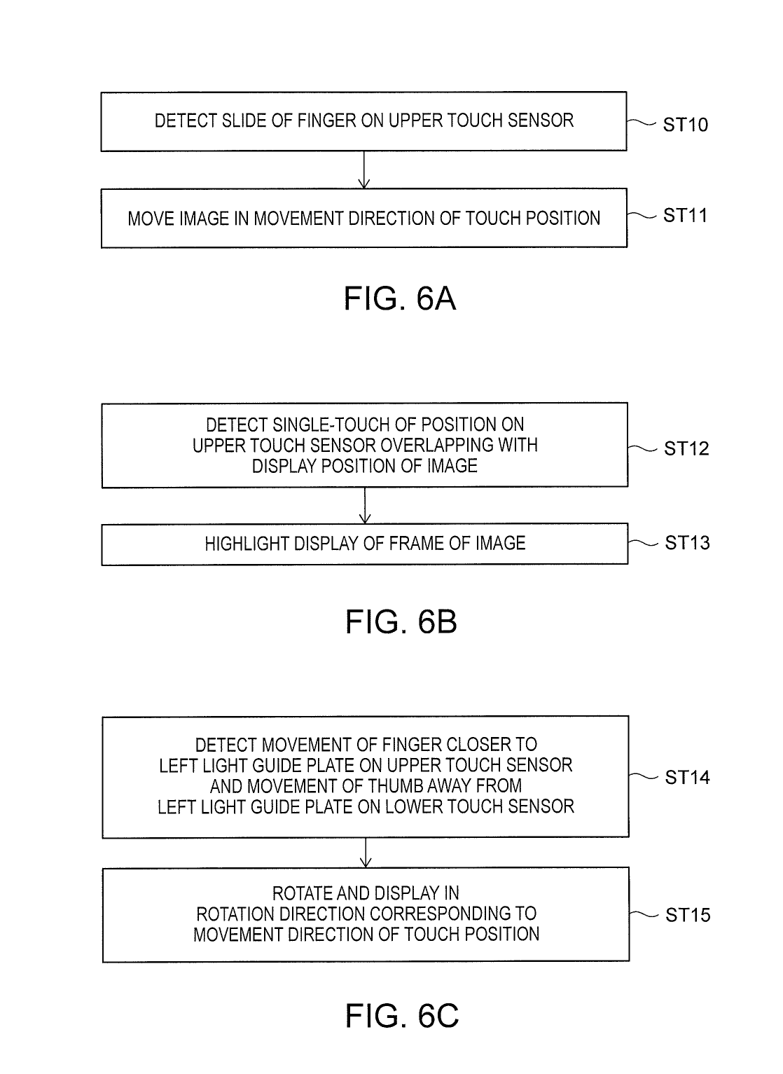

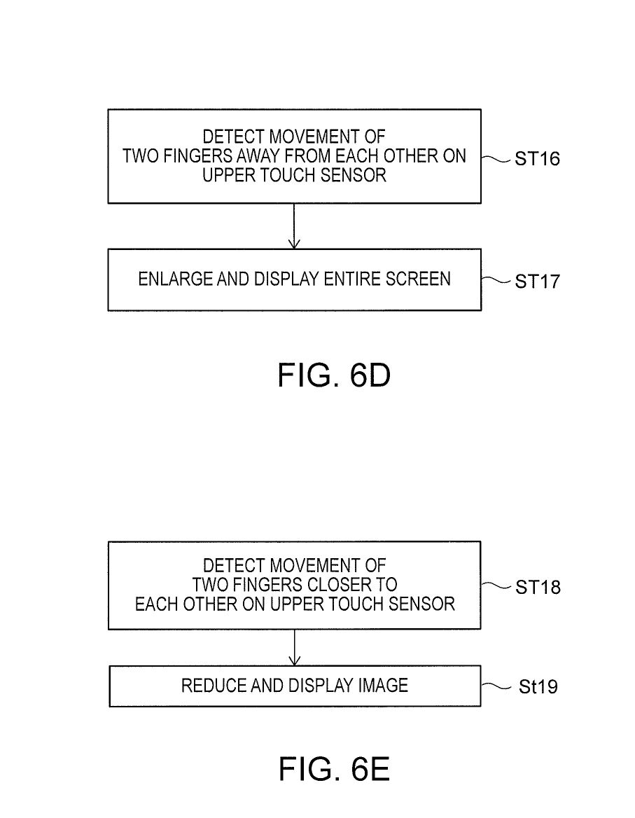

FIG. 3A shows that images i1 to i3 of a plurality of images are displayed. The three images displayed on the screen may be changed by the following operations. For example, in a state in which the screen shown in FIG. 3A is displayed, when the upper touch sensor 41 detects that the user has slid a finger to be closer to the left light guide plate 320 as shown in FIG. 3B on the upper touch sensor 41 (FIG. 6A, step ST10), the control unit 10 shifts the display positions of the three images i1, i2, i3 being displayed one by one toward the left light guide plate 320, and displays the next three images i2, i3, i4 as shown in FIG. 3C. That is, the control unit 10 moves the images in the direction of movement of the touch position (FIG. 6A, step ST11).

Obviously, in a state in which the screen shown in FIG. 3C is displayed, when the sensor detects that the user has slid the finger in the direction opposite to the direction shown in FIG. 3B, the control unit 10 returns the screen to the screen shown in FIG. 3A. The amount of movement of the image (the amount of shift of the display position) may vary depending on the amount of sliding of the finger. Further, the amount of movement and the speed of movement of the image may vary depending on the speed of sliding of the finger.

For example, the frame indicating the selected image may be moved by the following operations. As shown in FIG. 3C, in a state in which the center image i3 of the three images is selected, for example, as shown in FIG. 3D, when single-tap of a position 413 on the upper touch sensor 41 overlapping with the display position of the image i4 on the right light guide plate 310 is detected (FIG. 6B, step ST12), as shown in FIG. 3E, the control unit 10 highlights the frame of the right image of the three images as a selected image (FIG. 6B, step ST13). Note that the display position of the screen on the right light guide plate 310 is controlled by the control unit 10 and the right display drive part 21, and the relationships between the display positions of the display elements within the screen and the corresponding positions on the upper touch sensor 41 are previously recognized by the control unit 10.

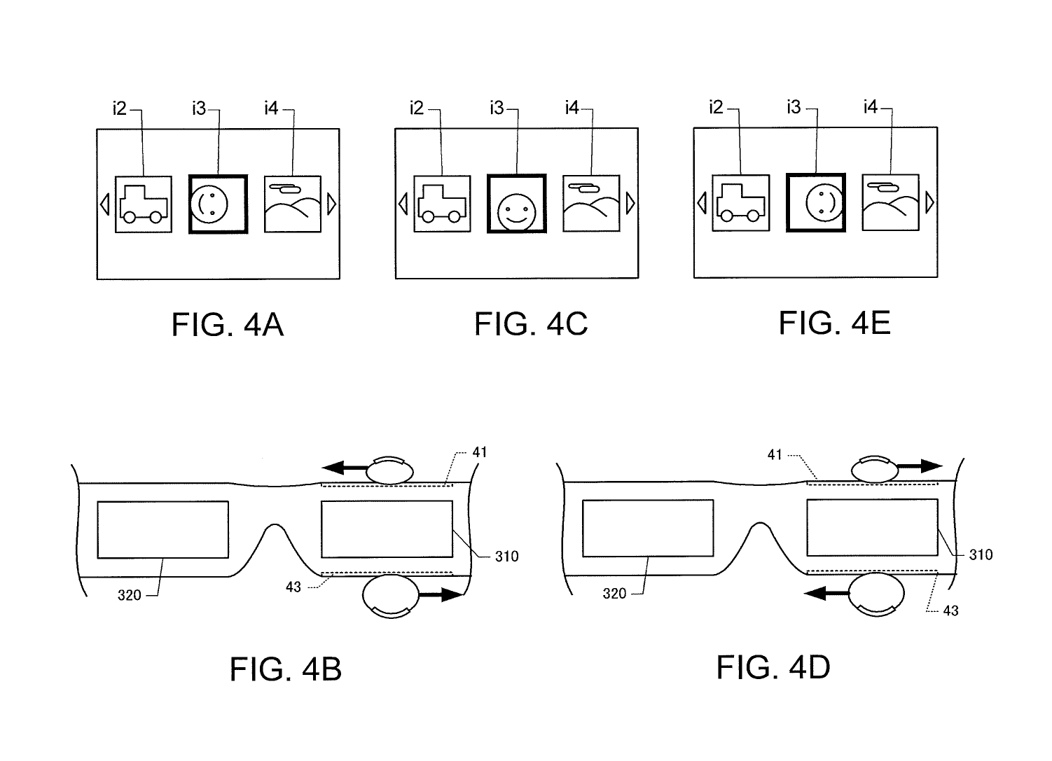

Further, the user may rotate the display image by the following operations using the upper and lower touch sensors. For example, the control unit 10 may rotationally display the selected image. Specifically, for example, as shown in FIG. 4A, in a state in which the image i3 is selected, when detecting that the user has moved e.g. the index finger closer to the left light guide plate 320 on the upper touch sensor 41 and e.g. the thumb away from the left light guide plate 320 on the lower touch sensor 43 (FIG. 6C, step ST14), the control unit 10 rotates and displays the image i3 to 90 degrees in the rotation direction corresponding to the movement direction of the touch position, i.e., in the counter-clockwise direction as shown in FIG. 4C in this case (FIG. 6C, step ST15). Specifically, the control unit 10 rotates the image in the same direction as the rotation direction when a tangent point of a virtual circle around the rotation center of the image and a virtual line in parallel to the movement direction of the touch position moves in a direction indicated by the virtual line on the circumference of the virtual circle.

When detecting that once the fingers have separated from the upper and lower touch sensors and the same operation (the operation shown in FIG. 4B) has been performed again, the control unit 10 further rotates and displays the image i3 to 90 degrees counter-clockwise as shown in FIG. 4E. Note that it is not necessary that the rotation angle of the image in single operation (the operation after the fingers are brought into contact with the upper and lower touch sensors and slid and before the fingers are separated) is in units of 90 degrees. For example, the rotation angle may vary depending on the amount of sliding of the fingers. Further, the rotation angle and the rotation speed of the image may vary depending on the speed of sliding of the fingers.

Further, in the state shown in FIG. 4E, when detecting that the user has moved the index finger away from the left light guide plate 320 on the upper touch sensor 41 and moved the thumb closer to the left light guide plate 320 on the lower touch sensor 43, the control unit 10 rotates and displays the selected image i3 clockwise to 90 degrees (return to the display shown in FIG. 4C). Note that the rotational display of the image may be performed not only in the case where the two touch positions with the display part in between move in the different directions from each other as described above but also in the case where one touch position does not move but only the other touch position moves. For example, in the case where the finger (e.g. the index finger) in contact with the upper touch sensor 41 is not moved, but the finger (e.g. the thumb) in contact with the lower touch sensor 43 is moved, the control unit 10 may rotate and display the image in the rotation direction corresponding to the movement direction of the touch position on the lower touch sensor 43.

As described above, the upper touch sensor 41 and the lower touch sensor 43 are provided on a part of the circumference of the display unit 30, and thereby, the user may sandwich the display unit 30 from the upside and the downside with two fingers and perform an operation of sliding at least one finger of the fingers. In the case of the operation, the display unit 30 may be supported by at least the other finger of the fingers sandwiching the display unit 30, and thereby, displacement of the display unit 30 with respect to the eye of the user may be reduced. The operation of sandwiching the display unit 30 from the upside and the downside with two fingers is not strange because the operation may be associated with the motion usually performed at adjustment of the feeling of wearing of the spectacles or the like. Accordingly, the user may perform the operation without giving a feeling of strangeness to the surroundings. This applies to the case where the touch sensors are provided in the left and right parts of the periphery of the display unit 30.

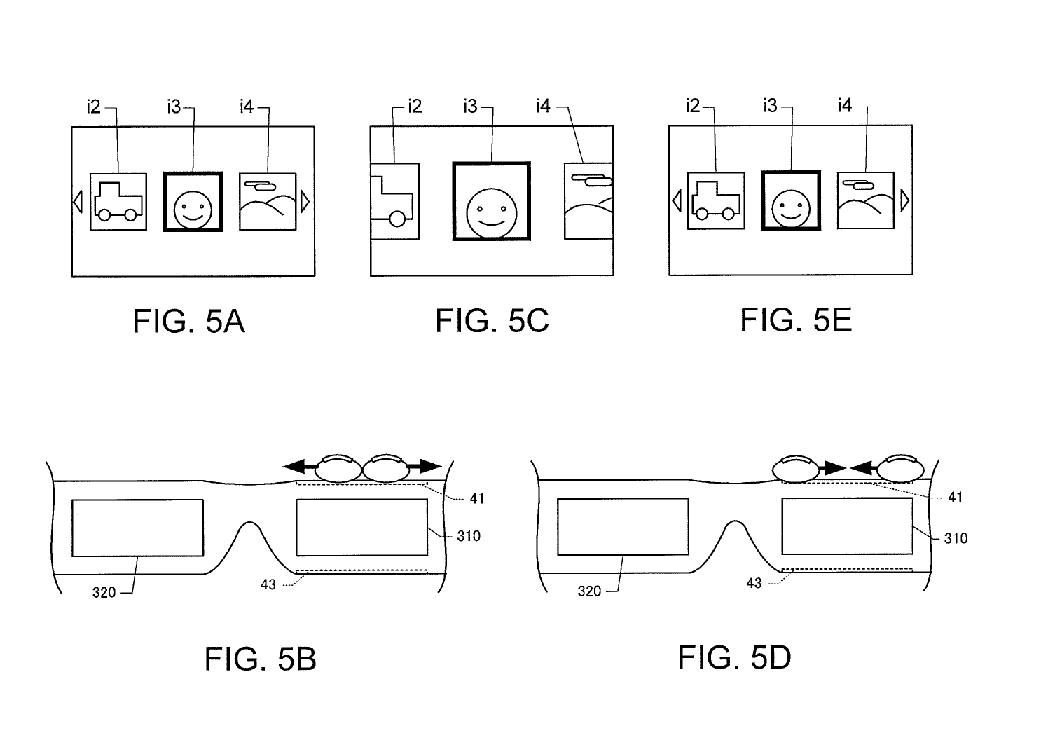

Furthermore, the user may enlarge or reduce the display image by the following operations. Specifically, for example, in the state in which a screen shown in FIG. 5A is displayed, when detecting that the user has moved two fingers (e.g. the index finger and the middle finger) away from each other on the upper touch sensor 41 as shown in FIG. 5B (FIG. 6D, step ST16), the control unit 10 enlarges and displays the entire screen being displayed as shown in FIG. 5C (FIG. 6D, step ST17). Or, in a state in which the screen shown in FIG. 5C is displayed, when detecting that the user has moved the index finger and the middle finger closer to each other (FIG. 6E, step ST18), the control unit 10 reduces and displays the screen being displayed as shown in FIG. 5E (FIG. 6E, step ST19). Obviously, the specification of enlarging and reducing display of the selected image may be employed.

Note that, when detecting a double-tap operation with respect to the position on the upper touch sensor 41 corresponding to e.g. the image being selected from the above described list display of the plurality of images, the control unit 10 may full-screen displays the image. Further, in a state in which one image is full-screen displayed on the screen, the slide operation shown in FIG. 3B, the rotational operation shown in FIGS. 4B and 4D, and the enlarging and reducing operation shown in FIGS. 5B and 5D may be enabled. For example, when the enlarging operation shown in FIG. 5B is performed in the state in which one image is full-screen displayed on the screen, the control unit 10 may enlarge the full-screen displayed one image and, when the slide operation shown in FIG. 3B is performed in the enlarged state, the control unit 10 may move the position to be displayed within the enlarged image. Furthermore, for example, when the rotational operation shown in FIG. 4B is performed in the state in which one image is full-screen displayed on the screen, the control unit 10 may rotate and display the image. When detecting the double-tap operation on the upper touch sensor 41 again, the control unit 10 may return the screen to the list display of the images.

As described above, even in the case where intuitive operation is harder only by the first operation unit 12 of the controller 100 in related art, the intuitive operation can be performed using the touch sensors provided along the periphery of the display unit of the attachment body 200 as in the embodiment. Note that, obviously, the same result as that of the above described operation may be obtained by operating the touch pad 124, the arrow key 126, the enter key 121, or the like of the controller 100.

### 2. Other Embodiments

The technical scope of the invention is not limited to the above described examples, but various changes can be obviously made without departing from the scope of the invention. For example, not only the slide, pinch-in, pinch-out, rotation, single-tap, and double-tap but also the operation of hold down (long press) or the like may be associated with some processing. For example, when detecting a hold-down or long press operation of the position of the upper touch sensor 41 corresponding to the selected image, the control unit 10 may display an operation menu and properties with respect to the selected image. Further, in the above described embodiment, the upper touch sensor 41 is used for movement and enlargement and reduction of the display position, however, obviously, the same operations may be performed using the lower touch sensor 43 or the movement and enlargement (or zoom in) and reduction (or zoom out) of the display elements may be realized by combinations of the operations with respect to the upper touch sensor 41 and the operations with respect to the lower touch sensor 43. Furthermore, the correspondence relations between the operation details and the processing details described above in the embodiment are just examples, and other correspondence relations may be employed. For example, in the above described embodiment, the operation of sliding the finger while being kept into contact with one location of the touch sensor is associated with the processing of moving the display position of the image, however, the operation may be associated with rotational display processing of the image.

Further, for example, the control unit 10 may select one of icon images of application programs in response to the operation for the upper touch sensor 41 or the lower touch sensor 43, and change the display form of the selected icon image. Furthermore, the control unit 10 may activate the application program corresponding to the selected icon image or its partial function in response to the operation for the upper touch sensor 41 or the lower touch sensor 43. When the application program is activated, the control unit 10 may change the image (display content) displayed on the display unit 30. The image changing in response to the operation for the upper touch sensor 41 or the lower touch sensor 43 may correspond to a part of the content displayed on the display unit 30 or may correspond to the entire of the content displayed on the display unit 30.

Further, in the above described embodiment, the two touch sensors of the upper touch sensor 41 and the lower touch sensor 43 are provided along the periphery of the display unit 30, however, a touch sensor may be provided in another part. For example, when the upper touch sensor and the lower touch sensor are provided in the right optical image display part 31 as in the embodiment, a right touch sensor may be further provided along the vertical direction in the right end part of the right optical image display part 31. Then, the display position of the image may be moved in the vertical directions by slide operations of the right touch sensor in the vertical directions. Further, for example, a position of a cursor within the screen in a two-dimensional coordinate system may be moved using the upper touch sensor and the right touch sensor.

Further, for example, when the first finger (e.g. the index finger) in contact with the upper touch sensor and the second finger (e.g. the thumb) in contact with the right touch sensor are slid away from each other, the image may be enlarged and displayed and, oppositely, the first finger and the second finger are slid closer to each other, the image may be reduced and displayed.

Furthermore, in the above described embodiment, the touch sensor is provided at the right optical image display part 31 side, however, obviously, the touch sensor may be provided at the left optical image display part 32 side or the touch sensors may be provided at both the right and left sides. When the touch sensors are provided at both the right and left sides, the touch sensors having the same functions may be symmetrically provided or the touch sensors may be asymmetrically provided. As an example of the asymmetric configuration, the touch sensor extending in the vertical direction may be provided along the left end part of the left optical image display part 32 and the upper touch sensor and the lower touch sensor may be provided at the right optical image display part 31 side.

Hereinafter, the other embodiment of the invention will be explained in the following order with reference to the accompanying drawings. In the respective drawings, corresponding component elements have the same signs and their overlapping explanation will be omitted.

### 3. Second Embodiment

### 3-1. Configuration

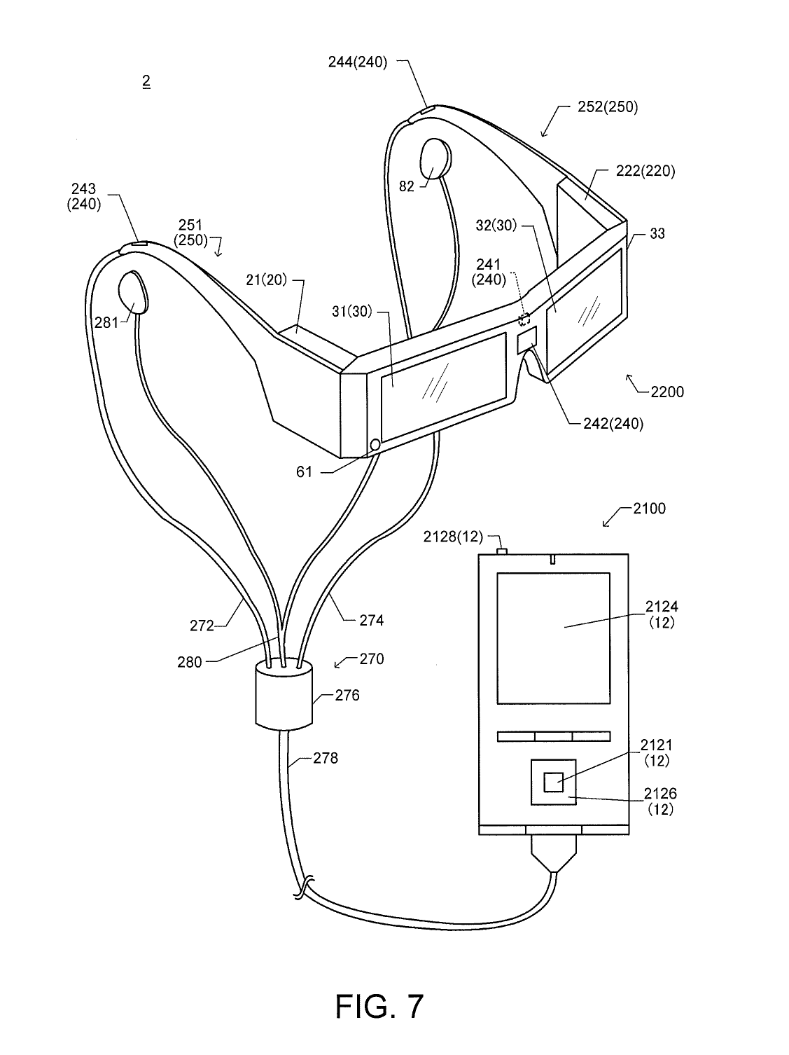

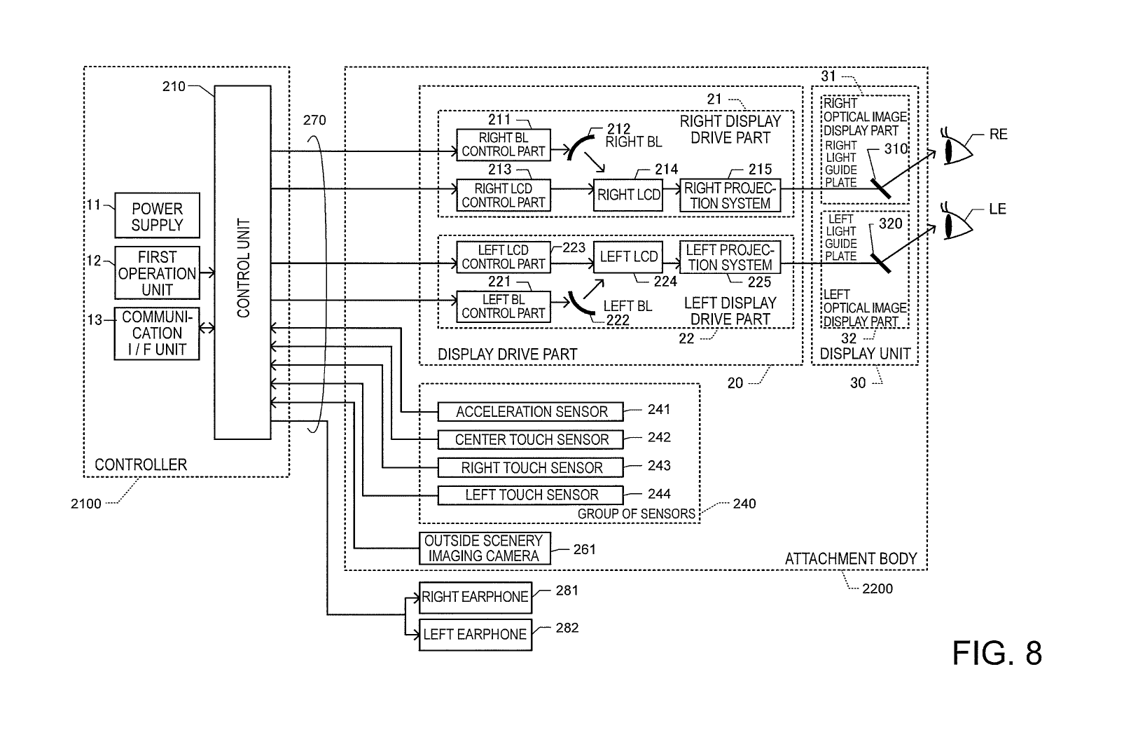

FIG. 7 is an explanatory diagram showing an appearance configuration of smart glasses 2 as a head mounted display (HMD). FIG. 8 is a block diagram functionally showing a configuration of the smart glasses 2. The smart glasses 2 of the embodiment are an optically transmissive HMD that enables a user to visually recognize an image (display image) displayed on a display unit and directly visually recognize an outside scenery.

The smart glasses 2 include an attachment body 2200 that allows a user to visually recognize a display image when attached to the head of the user, and a controller 2100 that controls the attachment body 2200. The attachment body 2200 has a spectacle shape in the embodiment. The attachment body 200 includes a display unit 30 as a part corresponding to lenses of the spectacle, a frame part 33 that supports the edges of the display unit 30, holding parts 250 connected to the frame part 33 and hanging on the ears of the user in wearing, a display drive unit 20, a group of sensors 240 that detect changes of the position with respect to the head of the user in wearing, and an outside scenery imaging camera 261. Note that, in the specification, “up”, “down, “left”, and “right” refer to “up”, “down, “left”, and “right” for a user when the attachment body 2200 is attached to the head of the user.

The display unit 30 includes a right optical image display part 31 and a left optical image display part 32. The right optical image display part 31 and the left optical image display part 32 are placed to be located in front of right and left eyes of the user when the user wears the attachment body 2200, respectively. The edges of the right optical image display part 31 and the left optical image display part 32 are fixed to the frame part 33. The holding parts 250 include a right holding part 251 and a left holding part 252. The right holding part 251 and the left holding part 252 hold the attachment body 2200 on the head of the user like temples of the spectacles. The display drive unit 20 includes a right display drive part 21 and a left display drive part 22. The right display drive part 21 and the left display drive part 22 are placed inside of the holding parts 250, i.e., on the sides of the head of the user when the user wears the attachment body 2200.

The right display drive part 21 includes a right backlight (BL) control part 211 and a right BL 212 that function as a light source, a right LCD control part 213 and a right LCD 214 that function as a display device, and a right projection system 215. The right projection system 215 includes a collimator lens that brings image light output from the right LCD 214 into parallelized luminous fluxes. The right optical image display part 31 includes a right light guide plate 310 and a dimmer plate (not shown). The right light guide plate 310 guides the image light output from the right projection system 215 to the right eye RE of the user while reflecting the light along a predetermined optical path.

The left display drive part 22 includes a left backlight (BL) control part 221 and a left BL 222 that function as a light source, a left LCD control part 223 and a left LCD 224 that function as a display device, and a left projection system 225. The left projection system 225 includes a collimator lens that brings image light output from the left LCD 224 into parallelized luminous fluxes. The left optical image display part 32 includes a left light guide plate 320 and a dimmer plate (not shown). The left light guide plate 320 guides the image light output from the left projection system 225 to the left eye LE of the user while reflecting the light along a predetermined optical path.

The right light guide plate 310 and the left light guide plate 320 are formed using a light-transmissive resin material or the like. The dimmer plates are optical elements having thin plate shapes, and provided to cover the front side of the attachment body 2200 on the opposite sides to the sides of the eyes of the user. The dimmer plates protect the light guide plates 310, 320 and suppress damage on the light guide plates 310, 320, adhesion of dirt, etc. Further, the light transmittance of the dimmer plates are adjusted, and thereby, the amount of outside light entering the eyes of the user may be adjusted and ease of visual recognition of the display image may be adjusted. Note that the dimmer plates may be omitted.

The group of sensors 240 include an acceleration sensor (motion sensor) 241, a center touch sensor 242, a right touch sensor 243, and a left touch sensor 244. The acceleration sensor 241 and the center touch sensor 242 are provided in positions corresponding to the glabella of the user (the part corresponding to the bridge of the spectacles) when the user wears the attachment body 2200. The acceleration sensor 241 is provided in the part of the frame part 33 corresponding to the bridge. The center touch sensor 242 is provided on the surface of the part corresponding to the bridge of the frame part 33, i.e., the surface opposite to the glabella side of the user. The right touch sensor 243 and the left touch sensor 244 are provided in positions at the upper side (head top side) of the ends of the right holding part 251 and the left holding part 252, respectively.

When the center touch sensor 242 detects contact of a finger or the like, the sensor outputs a signal representing the detection of contact to a control unit 210. Further, similarly, in the right touch sensor 243 and the left touch sensor 244, when detecting contact of a finger or the like, each sensor outputs a signal representing the detection of contact to the control unit 210. In the embodiment, it is only necessary that the respective touch sensors may at least detect presence or absence of contact of an object having a size to the degree of the tip of the finger. As the acceleration sensor 241, a three-axis acceleration sensor is employed in the embodiment. Note that, as will be described later, it is only necessary that at least acceleration in the vertical direction in wearing may be detected, and a single-axis acceleration sensor that detects acceleration in the direction of interest may be employed.

The outside scenery imaging camera 261 is provided in the frame part 33 at the right side of the right optical image display part 31. The outside scenery imaging camera 261 images an outside scenery as a scenery of the outside, and acquires an outside scenery image. The outside scenery imaging camera in the embodiment is a monocular camera, however, a stereo camera may be formed with another camera similarly provided at the left side of the left optical image display part 32.

The attachment body 2200 further has a connecting part 270 for connecting the attachment body 2200 to the controller 2100. The connecting part 270 includes a main body cord 278 connected to the controller 2100, a right cord 272 and a left cord 274 bifurcated from the main body cord 278, and a coupling member 276. The right cord 272 is inserted into a casing of the right holding part 251 from an end of the right holding part 251 and connected to the right display drive part 21, the outside scenery imaging camera 261, the right touch sensor 243, the center touch sensor 242, the acceleration sensor 241, etc. The left cord 274 is inserted into a casing of the left holding part 252 from an end of the left holding part 252 and connected to the left display drive part 22 and the left touch sensor 244. The coupling member 276 has a jack provided at the bifurcation point of the main body cord 278, the right cord 272, and the left cord 274 for connection of an earphone plug 280. From the earphone plug 280, a right earphone 281 and a left earphone 282 extend. The attachment body 2200 and the controller 2100 transmit various signals via the connecting part 270. A connector is provided on the opposite end to the coupling member 276 in the main body cord 278 and can be attached to or detached from the controller 2100.

The controller 2100 is a device for controlling the smart glasses 2. The controller 2100 includes the control unit 210, a power supply 11, an operation unit 12, and a communication I/F unit 13. The control unit 210 includes a CPU, a RAM, a ROM, a nonvolatile memory, etc. and controls the smart glasses 2 by the CPU executing various programs, which will be described later, recorded in the ROM and the nonvolatile memory using the RAM etc.

The operation unit 12 includes an enter key 2121, a touch pad 2124, an arrow key 2126, a power switch 2128, etc. The enter key 2121 is a key for outputting a signal that determines an operation performed in the controller 2100 when pressed down. The touch pad 2124 detects operations of fingers of the user etc. on the operation surface of the touch pad 2124, and outputs signals in response to the detected contents. The arrow key 2126 is a key, when a press operation is performed on the key corresponding to the up, down, left, and right directions for outputting a signal in response to the detected content. The power switch 2128 is a switch, when a slide operation of the switch is performed, switches the power status of the smart glasses 2.

The communication I/F unit 13 includes an interface circuit for wired communication (e.g. USB or the like) or wireless communication (e.g. Wi-Fi (registered trademark), Bluetooth (registered trademark), or the like) between an external apparatus such as a contents server, a television, or a personal computer and itself. The contents data such as sound data and image data acquired from an external apparatus is recorded in the nonvolatile memory.

The control unit 210 may execute various programs including a display control program and an image processing program, a sound processing program, a command receiving program, an imaging control program, and an image analysis program, which will be described later. The display control program allows the control unit 210 to realize a function of controlling generation and output of image lights by the respective left and right display drive parts 21, 22. Specifically, the function of individually controlling drive ON/OFF of the right LCD 214 by the right LCD control part 213, drive ON/OFF of the right BL 212 by the right BL control part 211, drive ON/OFF of the left LCD 224 by the left LCD control part 223, drive ON/OFF of the left BL 222 by the left BL control part 221, etc. is realized.

The image processing program allows the control unit 210 to realize a function of generating right-eye image data and left-eye image data based on image signals contained in data to be displayed and transmitting the data to the right display drive part 21 and the left display drive part 22, respectively. The sound processing program allows the control unit 210 to realize a function of acquiring sound signals contained in data to be reproduced, amplifying the acquired sound signals using amplifiers (not shown), and supplying the signals to speakers (not shown) within the left and right earphones 281, 282.

The command receiving program allows the control unit 210 to realize a function, when information representing an operation on the operation unit 12 is performed is acquired or when a position change of the attachment body 2200 with respect to the head of the user is detected based on the output of the group of sensors 240, of executing processing in response to the operation and changing processing details in response to the position change. The imaging control program allows the control unit 210 to realize a function of allowing the outside scenery imaging camera 261 to image an outside scenery and acquiring image data representing the outside scenery obtained as a result of the imaging. The image analysis program allows the control unit 210 to realize a function of analyzing an input image (e.g. the image captured by the outside scenery imaging camera 261) and detecting presence and absence of an object contained in the input image, the position and the size of the object, etc.

Further, the control unit 210 may execute an application program for reproducing contents data recorded in the nonvolatile memory (reproduction APP) and an application program for realizing augmented reality (AR) function (AR-APP). The control unit 210 may perform predetermined processing in response to the command of the user including reproduction of the contents data by executing the reproduction APP, the operating system (OS), the display control program, the image processing program, the sound processing program, the command receiving program, etc. Further, the control unit 210 may realize the augmented reality function of displaying characters, figures, etc. on the display unit 30 so as to be visually recognized in correspondence with predetermined objects contained in the outside scenery visually recognized through the display unit 30 by executing the AR-APP, the OS, the display control program, the image processing program, the command receiving program, the imaging control program, etc. Furthermore, the AR-APP also has a function of allowing the control unit 210 to perform calibration processing for that function in response to the command of the user.

### 3-2: Motion with Position Change and Processing in Response to Motion

Next, motions of the user that change the position of the attachment body 2200 with respect to the head and control details by the control unit 210 in this case will be explained.

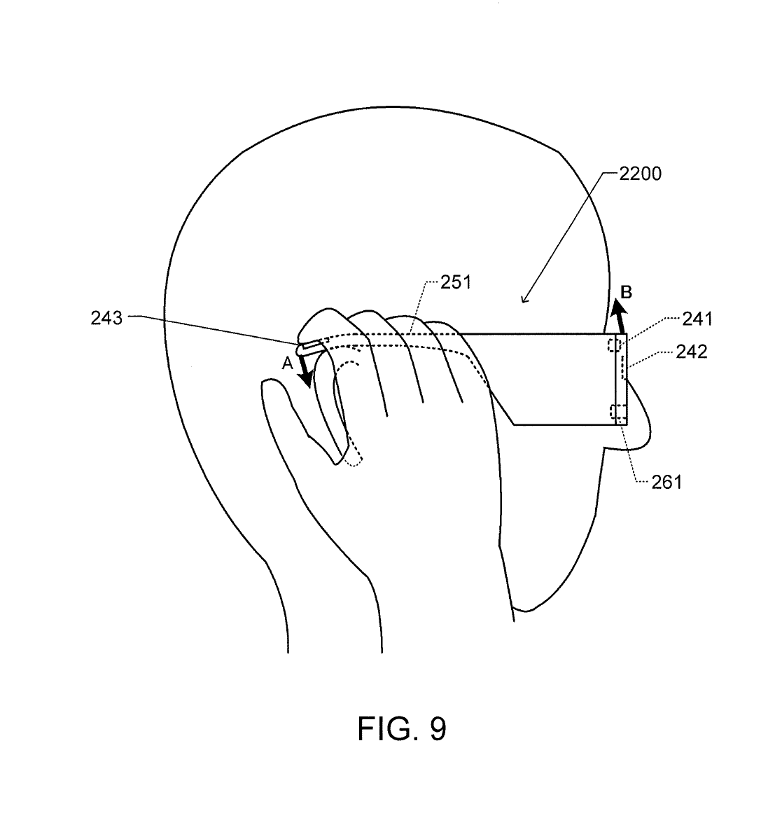

First, the control details of the control unit 210 when the motion with the above described position change is performed, for example, when an arbitrary piece of music in an reproduction list containing a plurality of pieces of music is reproduced will be explained. FIG. 9 shows the head of the user wearing the attachment body 2200 as seen from the right side. The connecting part 270, the left and right earphones 281, 282, and the controller 2100 are not shown in FIG. 9. The right touch sensor 243 and the left touch sensor 244 (not shown in FIG. 9) are provided in positions at the upper side (head top side) of the ends of the right holding part 251 and the left holding part 252 (not shown in FIG. 9), respectively. The ends of the left and right holding parts are ends of the holding parts located apart from the frame part 33 and, in a state in which the holding parts are hanging on the ears of the user, parts located farther from the frame part 33 than the parts in contact with the ears of the user. Usually, the ends are not in contact with the ears in the state.

As shown in FIG. 9, in a state in which a finger is in contact with the right touch sensor 243 provided on the end of the right holding part 251, when the user presses down to be closer to the ear (arrow A), the bridge part is separated from the nose and lifted on the principle of leverage with a fulcrum of the contact portion of the right holding part 251 with the ear (arrow B). The acceleration sensor 241 is provided in the bridge part, and the acceleration of the bridge part in the direction of the arrow B may be detected. Note that, though not illustrated in FIG. 9, with the above described press down of the right touch sensor 243, the same press down of the left touch sensor 244 may be performed. Further, only the press down of the left touch sensor 244 may be performed.

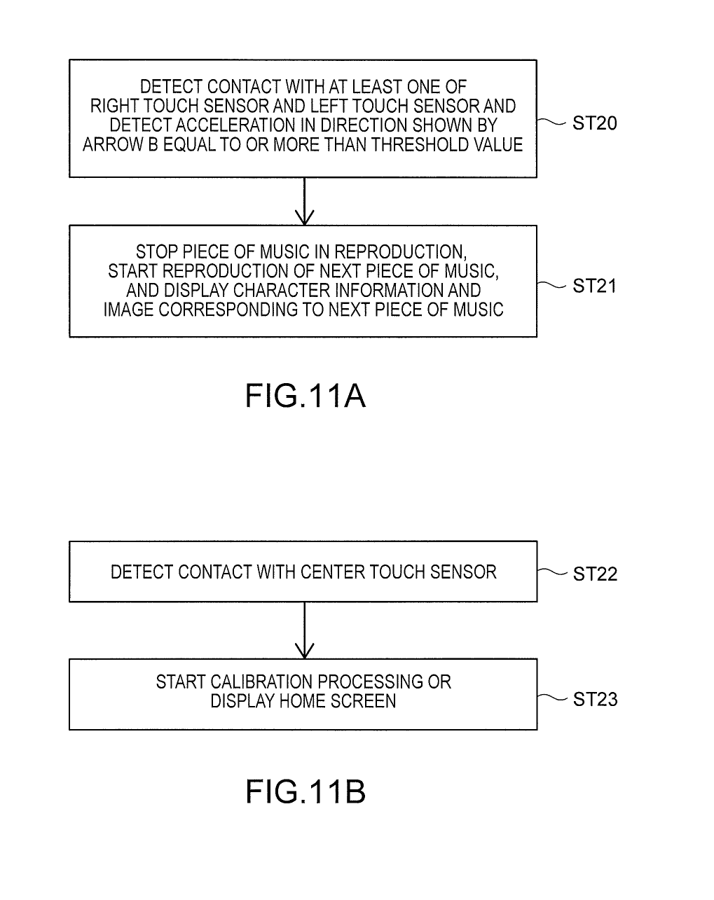

During reproduction of an arbitrary piece of music, the control unit 210 displays character information of a title etc. and an image etc. corresponding to the piece of music on the display unit 30. During reproduction of an arbitrary piece of music, when contact with at least one of the right touch sensor 243 and the left touch sensor 244 is detected and the acceleration sensor 241 detects the acceleration in the direction of the arrow B equal to or more than a predetermined threshold value (FIG. 11A, step ST20), the control unit 210 determines that the motion shown in FIG. 9 has been performed, and stops the piece of music in reproduction and starts reproduction of the next piece of music. With the start of reproduction of the next piece of music, the control unit 210 displays character information and an image corresponding to the next piece of music on the display unit 30 (FIG. 11A, step ST21). The piece of music to be reproduced next may vary depending on the reproduction mode or the like. For example, when the reproduction mode is a normal reproduction mode, reproduction of the next piece of music is started according to the order determined by a reproduction list. Or, for example, when the reproduction mode is a shuffle reproduction mode, a piece of music contained in the reproduction list is randomly selected as the next piece of music, and reproduction of the selected piece of music is started. Note that the above described threshold value may be determined by measurement of the acceleration in the bridge part when the above described motion is performed at manufacturing of products based on the actual measurement value, or may be customized by the user.

As described above, without the operation on the operation unit 12 of the controller 2100, the user easily input the switch command of the contents in reproduction to the smart glasses 2 by the simple motion shown in FIG. 9. Further, the motion of changing the position of the attachment body 2200 with respect to the head and the switching of the contents in reproduction are associated, and thereby, the smart glasses that can be intuitively operated suitably for the feeling of the user may be realized.

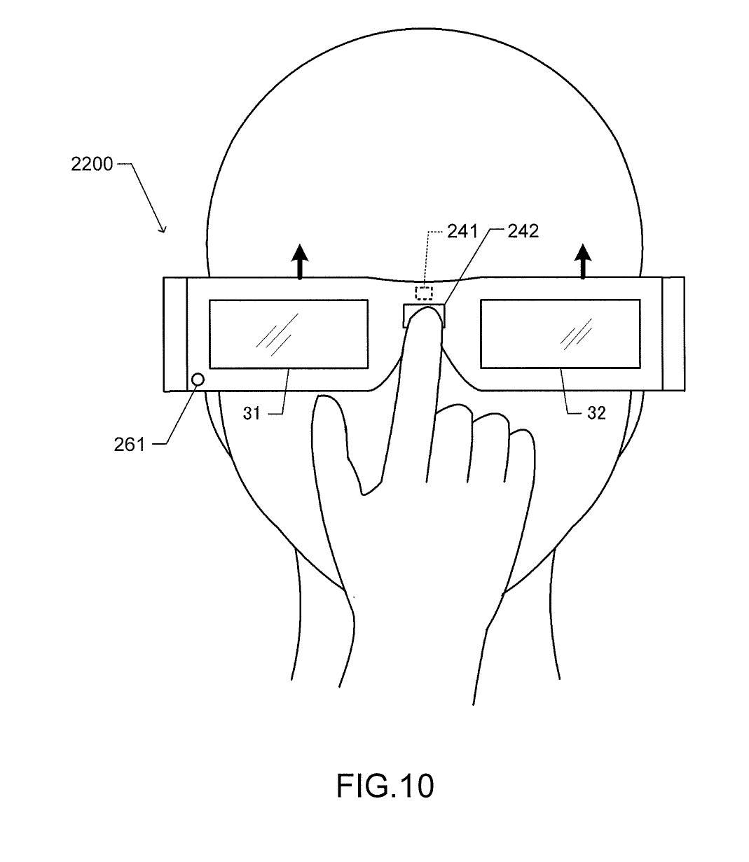

Next, control details of the control unit 210 when another motion of changing the position of the attachment body 2200 with respect to the head than the above describe motion is performed will be explained. FIG. 10 is a diagram of the head of the user wearing the attachment body 2200 viewed from the front side showing that the user performs a motion of pushing up the attachment body 2200 in contact with the center touch sensor 242 provided in the bridge part. Note that, in FIG. 10, the connecting part 270, the left and right earphones 281, 282, and the controller 2100 are not shown. When detecting the contact with the center touch sensor 242 (FIG. 11B, step ST22), the control unit 210 temporarily halts the processing performed until the motion is performed and starts calibration processing of the AR function (FIG. 11B, step ST23). When the calibration processing is performed, a calibration image is displayed on the display unit 30, and thereby, the display contents of the display unit 30 change before and after the motion.

In the calibration processing for the AR function, display position adjustment processing in response to the distance between eyes, alignment processing of the AR object with the real object, etc. are performed. Both of the processing may be performed or either processing may be performed in response to the motion shown in FIG. 10.

In the display position adjustment processing in response to the distance between eyes, first, the control unit 210 allows the right LCD 214 and the left LCD 224 to display the same calibration images. The user may visually recognize the calibration images through the left and right eyes. The user gives commands via the touch pad 2124 and the arrow key 2126 of the operation unit 12 so that the two calibration images may be visually recognized in alignment and at least one of the displayed two calibration images may be relatively moved to the other. At the time when the two calibration images may be visually recognized in alignment, the user gives notice via the enter key 2121 of the operation unit 12 or the like. The control unit 210 adjusts the display positions of the images on the LCDs based on the positions of the two calibration images with respect to the LCDs at the time in response to the notice.

In the alignment processing of the AR object with the real object, first, the control unit 210 controls the display drive unit 20 to display the calibration images on the display unit 30. With the display, the control unit 210 recognizes and tracks a reference real object corresponding to the calibration images via the outside scenery imaging camera 261. Under the condition, the user moves the positions of the calibration images on the display unit 30 via the operation unit 12. Then, notice is given to the control unit 210 via the operation unit 12 at the time when the user visually perceives that the calibration images overlap with the reference real object (at least one of the positions, sizes, and orientations may nearly coincide). The control unit 210 acquires parameters corresponding to the position in the captured image of the reference real object at the time and the position of the calibration images on the display unit 30 in response to the notice. Then, in AR display, the display position of the AR object is adjusted based on the parameters. Note that it is desirable that the alignment processing of the AR object with the real object is performed after the adjustment processing of the display position in response to the distance between eyes.

When the user desires to perform calibration of AR, it is conceivable that the user starts calibration after adjustment of the position of the attachment body 2200 with respect to the head so that the feeling of attachment may be comfortable. In the case of the embodiment, the motion of the position adjustment and the start of the calibration processing are associated, and thereby, the user may input a start command of the calibration in an intuitive and simple method. Here, the range of the positional relationship providing the comfort to the feeling of attachment may slightly vary, and, if the position with respect to the head is adjusted, it may be possible that the positional relationship when the previous calibration is made is not completely reproduced. Further, the positional relationship between the head and the head mounted display with which the user feels comfortable in the feeling of attachment may vary depending on the posture of the user, whether or not the object to be seen is located at hand or far away. In the embodiment, from the standpoints, when the user changes the position of the attachment body 2200 with respect to the head, calibration is started.

As the motion of changing the position of the attachment body 2200 with respect to the head, various other motions than the motions shown in FIGS. 9 and 10 are conceivable. In the case where the user does not desire to switch the contents in reproduction or start the calibration processing, but desires to adjust the position of the attachment body 2200 with respect to the head for comfort in the feeling of attachment, other motion than the motions shown in FIGS. 9 and 10 may be performed. In this manner, situations that the contents are switched and the calibration processing is started despite the intention may be avoided.

For correction of the feeling of attachment of the attachment body 2200 or the like, usually, the position with respect to the head is changed by touching of a part of the attachment body 2200, and the above described motions are not strange. Therefore, the user may input a desired command to the smart glasses 2 by performing the above described motions without giving a feeling of strangeness to the surroundings.

### 4. Other Embodiments

The technical scope of the invention is not limited to the above described examples, various changes can obviously be made without departing from the scope of the invention. For example, the correspondences of the specific motions and the predetermined processing as described above in the embodiments are just examples, and other various embodiments are conceivable. For example, in the above described embodiments, the explanation that the calibration processing of AR is performed when the motion of pushing up the bridge part is performed is made, however, when the motion is performed, the control unit 210 may switch the display contents of the display unit 30 to display of a home screen. For example, when a screen of an application in activation is displayed before detection of the contact with the center touch sensor 242, the control unit 210 may change from the display of the screen of the application to the display of the home screen after detection of the contact (FIG. 11B, step ST23). As a result, without the operation of the operation unit 12 of the controller 100, the user may easily switch the display to the home screen.

Furthermore, in the above described embodiments, the form that, when the touch sensor provided in the holding part (temple) detects the contact of the finger or the like and the acceleration sensor provided on the bridge detects acceleration, the control unit 210 executes the predetermined processing of switching the contents in reproduction is explained. However, when the touch sensor provided in the holding part detects the contact of the finger or the like, predetermined processing may be executed regardless of output of the acceleration sensor. In the above described embodiments, the predetermined processing including start of the calibration processing of AR is executed when the contact with the center touch sensor 242 is detected, however, the predetermined processing may be executed when upward (in the direction from the chin to the top of the head of the user) acceleration by the acceleration sensor 241 is detected in addition to the detection of the contact with the center touch sensor 242.

Further, in the above described embodiments, the predetermined processing is executed when the contact with the center touch sensor 242 provided at the side of the bridge part opposite to the glabella side is detected. However, the touch sensor provided in the bridge part may be provided in e.g. a part corresponding to the nose pad in contact with the nose. In this case, when the touch sensor provided in the part corresponding to the nose pad detects the touch sensor apart from the nose, the control unit 210 may determine that the motion of pushing up the bridge has been performed, and execute predetermined processing.

Furthermore, as the positions where the touch sensor and the motion sensor are provided, various other forms are conceivable with reference to motions generally performed for adjustment of the feeling of wearing of spectacles. For example, the touch sensor may be provided closer to the frame part 33 side than the contact part with the ear in the holding part (temple). In this case, the control unit 210 may detect the motion of adjusting the position of the attachment body 2200 while touching the frame part 33 side of the holding part anterior to the ear based on the output of the motion sensor and the touch sensor. Or, the touch sensor may be provided in a part located upside or downside of the right optical image display part 31 or the left optical image display part 32 in the frame part 33. In this case, the control unit 210 may detect e.g. a motion by the user of pushing up the downside part of the right optical image display part 31 in the frame part 33 with the index finger based on the output of the motion sensor and the touch sensor. Or, for example, the control unit 210 may detect a motion of pinching with the index finger and the thumb, lifting, and pushing the upside part and the downside part of the frame part 33 of the right optical image display part 31 toward the head side or the like based on the output of the motion sensor and the touch sensor. Note that, for example, the motion sensor may be provided on one end of the left and right ends of the frame part 33 or in the holding part, not limited to the bridge part. As the motion sensor, not only the acceleration sensor but also a gyro sensor or a geomagnetic sensor may be employed.

In addition, in the above described embodiments, the spectacle-shaped HMD is cited as an example of the HMD, however, obviously, the invention may be applied to other HMDs than the spectacle-shaped HMD.

A head mounted display comprising a sensor that detects a change in position with respect to a head of a user; and a control unit that executes predetermined processing when the change in position is detected.

The head mounted display having a spectacle shape, wherein the sensor includes a touch sensor provided in a bridge.

The head mounted display having a spectacle shape, wherein the sensor includes a touch sensor provided in a temple.

The head mounted display wherein the sensor includes a touch sensor and a motion sensor, and the control unit executes the predetermined processing when the touch sensor detects contact and the motion sensor detects a motion.

The head mounted display wherein, when detecting the change in position, the control unit switches contents in reproduction.

The head mounted display wherein, when detecting the change in position, the control unit starts calibration processing of an augmented reality function.

The head mounted display further comprising a display unit that displays an image, wherein, when detecting the change in position, the control unit allows the display unit to display an image representing a home screen.

A control method, in a head mounted display including a sensor that detects a change in position with respect to a head of a user, and a control unit, comprising executing predetermined processing by the control unit when the change in position is detected.

What is claimed is:

1. A head mounted display comprising:
a display unit that displays an image;
a touch sensor provided along at least a part of a periphery of the display unit; and
a control unit that changes the image in response to an operation detected by the touch sensor.

2. The head mounted display according to claim 1, wherein the control unit changes the image in response to the operation by which two touch positions move in different directions from each other along the periphery.

3. The head mounted display according to claim 2, wherein the touch sensor includes a first touch sensor and a second touch sensor having a positional relationship sandwiching the display unit with the first touch sensor, and
the control unit rotates the image in response to the operation represented by a movement of a first touch position in a first direction detected by the first touch sensor and a movement of a second touch position in a second direction opposite to the first direction detected by the second touch sensor.

4. The head mounted display according to claim 2, wherein the control unit reduces the image in response to the operation by which the two touch positions move closer to each other, and enlarges the image in response to the operation by which the two touch positions move away from each other.

5. The head mounted display according to claim 1, wherein the control unit moves a display position of the image in response to the operation by which one touch position moves along the periphery.

6. A control method for a head mounted display including a display unit that displays an image, and a touch sensor provided along at least a part of a periphery of the display unit, comprising changing the image in response to an operation detected by the touch sensor.

7. A program allowing a head mounted display including a display unit that displays an image, and a touch sensor provided along at least a part of a periphery of the display unit to realize a function of changing the image in response to an operation detected by the touch sensor.

8. A program in a head mounted display including a sensor that detects a change in position with respect to a head of a user, and a control unit, allowing the control unit to realize a function of executing predetermined processing when the change in position is detected.
